(19) United States
(12) Patent Application Publication
(10) Pub. No.: US 2026/0030082 A1
(43) Pub. Date: Jan. 29, 2026

(54) PREDICTING COMPUTER PLATFORM FAILURES BASED ON SENSITIVE DEPENDENCIES OF OPERATING BEHAVIOR METRICS

(71) Applicant: HEWLETT PACKARD ENTERPRISE DEVELOPMENT LP, Spring, TX (US)

(72) Inventor: Thomas Golway, Plandome, NY (US)

(21) Appl. No.: 18/784,797

(22) Filed: Jul. 25, 2024

(51) Int. Cl. G06F 11/00; G06F 11/34

(52) U.S. Cl. CPC G06F 11/008; G06F 11/3452

(57) ABSTRACT

A technique includes aggregating a time sequence of samples, where each sample has a plurality of dimensions corresponding to respective metrics associated with an operating behavior of a computer platform. Each sample includes, for each dimension, a measurement of the metric that corresponds to the dimension. The technique includes determining statistics of the measurements; and based on the statistics and the measurements, determining metric sensitive dependencies for respective samples. The technique includes, based on the metric sensitive dependencies, predicting a failure of the computer platform.

### BACKGROUND

A server is a computer platform that provides information and services over a network to clients. Modern server architectures are growing increasingly intricate, with a wide range of components and interdependencies.

### BRIEF DESCRIPTION OF THE DRAWINGS

FIG. 1 is a block diagram of a computer network that includes a failure event forecasting engine to predict a failure of a computer platform based on a sensitive dependency of operating behavior metrics of the computer platform, according to an example implementation.

FIG. 2 is a block diagram of a failure event forecasting engine, according to an example implementation.

FIG. 3 is a flow diagram depicting a technique to determine a failure event probability for a computer platform and estimate a time to a failure event, according to an example implementation.

FIG. 4 is an illustration of a technique to use a history of failure event probabilities to predict a time to a failure event, according to an example implementation.

FIG. 5 is a block diagram of a baseboard management controller that includes a failure event forecasting engine, according to a further example implementation.

FIG. 6 is an illustration of system-readable instructions that, when executed by a system, cause the system to predict a failure of a computer platform based on an operating behavior metric sensitive dependency, according to an example implementation.

FIG. 7 is a flow diagram depicting a technique to predict a failure of a computer platform based on an operating behavior metric sensitive dependency according to an example implementation.

FIG. 8 is a schematic diagram of a computer platform that includes a failure event forecasting engine to predict a failure of a host based on an operating behavior metric sensitive dependency, according to an example implementation.

### DETAILED DESCRIPTION

The complexities of modern server architectures, combined with technology's continuous evolution, present challenges in ensuring server reliability, especially with the shift towards hybrid and cloud-based infrastructures. Although a business may expect and therefore plan for a server to be in service for an expected lifetime, the server may unexpectedly fail prematurely. Unexpected server failures may adversely impact a business, resulting in operational disruptions, decreased productivity and potential revenue losses. Accurately and timely predicting premature server failures allows appropriate preemptive actions (e.g., server replacements, field repairs or other remedial measures) to be undertaken to prevent or at least mitigate such harmful impacts.

In one approach, machine learning may be used to predict server failures. With this approach, servers are associated with specific respective server classes, and server class-specific machine learning models monitor and evaluate behaviors of the servers for purposes of predicting server failures. This approach has a relatively large resource consumption footprint. Consequentially, the server failure prediction may be challenging to implement on a server whose failure is being predicted, and if implemented remotely, the server failure prediction does not have local access to all of the measurable components of the server. Moreover, this approach may be relatively insensitive to granular nuances that may be manifested in real time on a particular individual server.

In accordance with example implementations that are described herein, a failure event forecasting engine monitors operating behavior-related measurements of a computer platform (e.g., a server) and applies principles of mathematical chaos theory to the measurements for purposes of predicting the computer platform's failure. As described further herein, the failure event forecasting engine has a relatively resource small resource consumption footprint and may be a component of the computer platform whose failure is being predicted. The failure event forecasting engine's failure prediction, in accordance with example implementations, includes two components: 1. a likelihood, or probability (called the “failure event probability” herein), of a failure event for the computer platform; and 2. a predicted, or estimated, time to the failure event (also referred to herein as the computer platform's estimated “remaining life”).

In the context used herein, a computer platform experiencing a “failure event” refers to the computer platform degrading to a state in which the computer platform can no longer reliably provide one or multiple primary functions (e.g., providing an operating system, providing application operating environments, executing applications, performing routing, performing switching or performing or providing one or multiple other main purposes or roles associated with the computer platform). The failure event forecasting engine, in accordance with example implementations, continually updates both the predicted failure event probability and the estimated remaining life in real time or near real time. These continual updates provide ample notice of any predicted premature failure of the computer platform and allow sufficient time for preemptive measures to be undertaken to address a predicted failure before the computer platform fails.

Operating behavior metrics of a computer platform exhibit a behavior, which is referred to in chaos theory as “self-similarity.” In this context, “self-similarity” refers to a behavior among a particular set of variables such that variations to one variable triggers changes to all variables proportionately to the original change while retaining all statistical properties, regardless of scale. The variables may exhibit a strict self-similarity (strict proportionate changes) or a lesser degree of self-similarity, depending on a sensitive dependency of the variables. The sensitive dependency is a measure of the correlation of the variable changes. As described herein, the failure event forecasting engine uses the sensitive dependency (called the “metric sensitive dependency” herein) of operating behavior metrics of a computer platform as a predictor of a failure event for the computer platform.

In accordance with example implementations, the operating behavior metrics are associated with measurable, or observable, components of the computer platform. A computer platform may have a wide variety of measurable components, such as central processing units (CPUs), graphics processing units (GPUs), memory devices, storage devices, networking devices, fan speed sensors, temperature sensors, as well as other components. A given measurable component may be associated with one or multiple operating behavior metrics. In examples, an operating behavior metric may be a CPU utilization, a memory utilization, a temperature, a fan speed, a memory error statistic, or other characterization of a state or condition of the computer platform. The operating behavior metrics have respective time-varying values, or measurements. As described herein, the failure event forecasting engine, in accordance with example implementations, time samples operating behavior metric measurements of a computer platform and predicts a failure of the computer platform based on the metric sensitive dependencies that are exhibited by the respective measurement samples.

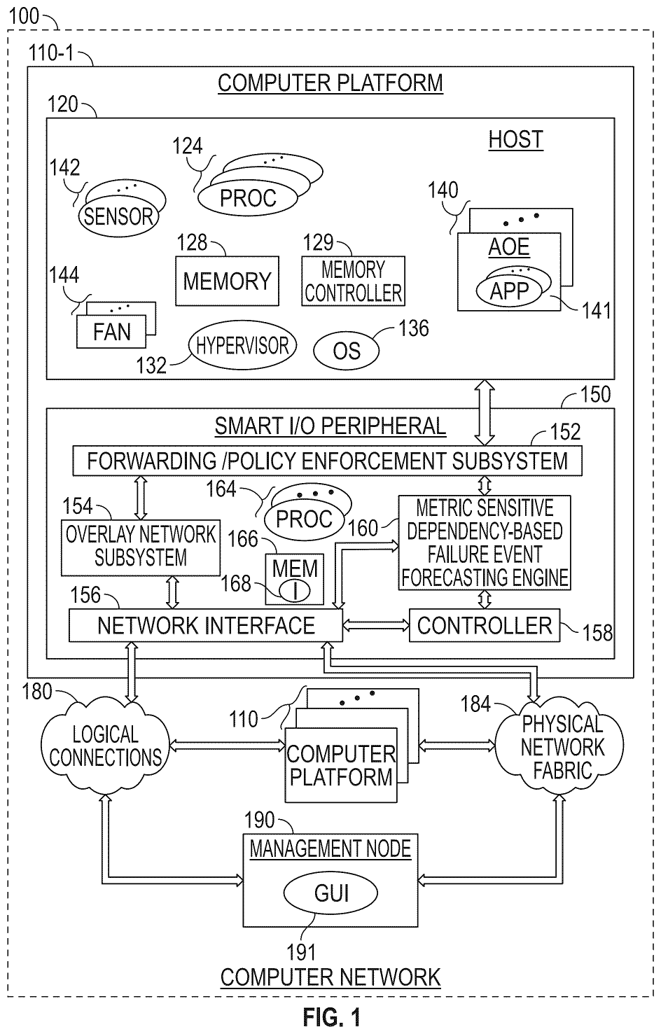

As a more specific example, FIG. 1 depicts a computer network 100 in accordance with example implementations. The computer network 100 includes multiple computer platforms 110 that are interconnected by logical connections 180 and physical network fabric 184. In this context, a “computer platform” refers to a unit that includes a chassis and hardware that is mounted to the chassis, where the hardware is capable of executing machine-executable instructions (or “software”). In examples, a computer platform 110 may be a server, such as a blade server, a rack server or a tower server. In other examples, a computer platform 110 may be a network device, such as a network switch, a router, a top-of-the-rack (TOR) switch, a gateway, a bridge, or other network fabric component. In other examples, a computer platform 110 may be a client, a desktop computer, a smartphone, a storage array, a smart television, a laptop computer, a tablet computer, wearable computer or any other processor-based device.

Depending on the particular implementation, the computer platforms 110 of the computer network 100 may be of the same type (e.g., servers having the same model number) or, alternatively, the computer platforms 110 may be a heterogenous mixture of architectures and/or component compositions. In an example, the computer platforms 110 are a mixture of servers of different classes, models and/or versions. In another example, the computer platforms 110 are a mixture of network devices (e.g., switches, routers, bridges, gateways and so forth). In another example, the computer platforms 110 are a mixture of network devices of different classes, models and/or versions. In another example, the computer platforms 110 are a mixture of servers and network devices.

In general, the physical network fabric 184 may be associated with one or multiple types of communication networks, such as (as examples) Fibre Channel networks, Compute Express Link (CXL) fabric, dedicated management networks, local area networks (LANs), WANs, wireless networks, or any combination thereof.

FIG. 1 depicts components of a specific exemplary computer platform 110-1. Other computer platforms 110 may have similar components to the computer platform 110-1 or may have different components than the computer platform 110-1. Regardless of its particular form or architecture, in accordance with example implementations, each computer platform 110 has a metric sensitive dependency-based, failure event forecasting engine 160 (called the “failure event forecasting engine 160” or “engine 160” herein). The failure event forecasting engine 160 applies principles of mathematical chaos theory for purposes of predicting a failure event for its associated computer platform 110. More specifically, in accordance with example implementations, the failure event forecasting engine 160 monitors measurements of operating behavior metrics of its associated computer platform 110, and based on this monitoring, as described herein, the engine 160 estimates a failure event probability for the computer platform 110. Moreover, as further described herein, the failure event forecasting engine 160 uses a recent history of failure event probabilities for the computer platform 110 to predict the computer platform's remaining life (which may also be referred to as a “time to a failure event”).

In accordance with some implementations, the failure event forecasting engines 160 report their respective failure event probabilities and estimated remaining lives to a control plane of the computer network 100. For the example implementation of FIG. 1, the control plane may include one or multiple management nodes 190 (e.g., remote management servers) of the computer network 100. The management node 190 may be connected by logical connections 180 and physical network fabric 184 to the computer platforms 110. The management node 190, in accordance with example implementations, provides a dashboard, or graphical user interface (GUI) 191. In an example, the GUI 191 may display, in real time or near real time, failure event probabilities and estimated remaining lives for the computer platforms 110, as updates are received from the failure event forecasting engines 160. In this way, appropriate and timely preemptive action(s) may be initiated (e.g., initiated automatically or initiated by system administrators) when a particular computer platform 110 is likely to fail (e.g., deemed likely to fail based on a comparison of the failure event probability to a certain percentage threshold) or is predicted to fail within a certain time period (e.g., fail within a day, week, month or other unit of time-based threshold).

Moreover, in accordance with some implementations, the failure event forecasting engine 160 is constructed to send out an alert (e.g., send an alert to the management node 190 and/or message a system administrator) in response to its associated computer platform 110 having an estimated remaining life that is less than the computer platform's expected remaining life. In an example, an expected remaining life for a particular computer platform 110 may be derived from a mean time between failures (MTBF) or other statistic for the computer platform 110 based on the computer platform's type, model number, or other association.

For the example implementation that is depicted in FIG. 1, the computer platform 110-1 has one or multiple hardware processors 124 (also called “processors 124” herein). In general, a “hardware processor” refers to a collection of one or multiple processing cores (e.g., CPU cores and/or GPU cores), which execute machine-readable instructions. In general, the instructions are stored in a memory 128 of the computer platform 110-1. The hardware processor 124 is an example of one of many measurable components of the computer platform 110-1, and as such, the hardware processor 124 is associated with one or multiple measurable operating behavior metrics.

In an example of an operating behavior metric, a hardware processor 124 may have one or multiple associated CPU utilizations. In an example, a CPU utilization for a hardware processor 124 may be a percentage usage of all CPU cores of the hardware processor 124. In another example, a CPU utilization for a hardware processor 124 may be a percentage usage of all of its CPU cores when the hardware processor 124 executes user level processes. In another example, a CPU utilization for a hardware processor 124 may be a percentage usage of all of its CPU cores when the hardware processor 124 executes kernel level processes. In another example, a CPU utilization for a hardware processor 124 may be a percentage usage of all of its CPU cores when the hardware processor 124 executes nice priority processes. The CPU utilization(s), in accordance with some implementations, may be provided by an operating system 136 of the computer platform 110-1.

The memory 128 is another example of a measurable component of the computer platform 110-1. The memory 128, in general, may be implemented using a collection of physical memory devices. In general, the memory devices that form the memory 128, as well as other memories and storage media that are described herein, are examples of non-transitory machine-readable storage media. In accordance with example implementations, the machine-readable storage media may be used for a variety of storage-related and computing-related functions of the computer platform 110-1. As examples, the memory devices may include semiconductor storage devices, flash memory devices, memristors, phase change memory devices, magnetic storage devices, a combination of one or more of the foregoing storage technologies, as well as memory devices based on other technologies. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

The memory 128 may be associated with one or multiple measurable, operating behavior metrics for the computer platform 110-1. In an example, an operating behavior metric may be a memory utilization. In another example, a memory utilization may be a percentage of memory (e.g., the entire memory or a subpart thereof) being currently used, excluding buffer and cache memory. In another example, a memory utilization may be a percentage of memory being currently used as buffer and cache memory. In another example, a memory utilization may be a percentage of available memory being currently used as a virtual file system that is shared among processes. In accordance with some implementations, the memory utilization(s) may be provided by the operating system 136.

In another example of an operating behavior metric associated with the memory 128, an operating behavior metric may be an error code correction (ECC) statistic that is associated with ECC memory (e.g., the entire memory 128 or a portion thereof). In an example, a memory controller 129 of the computer platform 110-1 may perform error corrections for ECC memory, and the error corrections may include correctable errors (i.e., errors for which the data is recovered using ECC) and non-correctable errors (i.e., errors for which the data is not recoverable). In an example, the operating system 136 may provide statistics about correctable and non-correctable memory errors. In examples, operating behavior metrics include respective time rates of correctable and/or non-correctable memory errors. In other examples, operating behavior metrics include numbers of correctable and/or non-correctable memory errors.

In another example of measurable components of the computer platform 110-1, one or multiple sensors 142 of the computer platform 110-1 may provide signals or data representing measurable operating behavior metrics for the computer platform 110-1. In an example, speed sensors 142 provide signals representing speeds of respective fans 144 (e.g., CPU fans, GPU fans or other fans) of the computer platform 110-1. In another example, temperature sensors 142 provide signals representing temperatures of respective components and/or locations of the computer platform 110-1 (e.g., CPUs, GPUs, the motherboard, as well as other devices and locations).

In other examples, other measurable components of the computer platform 110-1 may include a storage device, a network interface controller, a power supply or other hardware components.

In other examples, one or multiple operating behavior metrics may be provided by and/or associated with software-related components of the computer platform 110-1. In an example, an operating behavior metric may correspond to virtual machine stoppages, such as the number and/or time rate of unexpected virtual machine stoppages reported by a hypervisor 132 of the computer platform 110-1. In another example, an operating behavior metric may correspond to application crashes for the computer platform 110-1, such as the number and/or time rate of application crashes on the computer platform 110-1.

The failure event forecasting engine 160 may consider other and/or different operating behavior metrics than those specifically mentioned herein. In the context used herein, an “operating behavior metric” is a measurable characterization (e.g., a number, an occurrence, a statistic, a time rate or other representation) of a hardware fault, environmental variable anomaly, a software fault, a power state transition (e.g., power up or reset) or other condition, state or activity of a computer platform.

The failure event forecasting engine 160, in accordance with example implementations, is a component of a management controller of the computer platform 110. For the example computer platform 110-1 depicted in FIG. 1, the management controller is a smart input/output peripheral 150 (also called a “data processing unit,” or “DPU”). In an example, the computer platform 110-1 may have a host 120 and one or multiple smart I/O peripherals 150. The particular smart I/O peripheral 150 containing the failure event forecasting engine 160 aggregates measurements of operating behavior metrics that are provided by the host 120.

In the context used herein, a “host” refers to an entity that has an unabstracted view of resources (e.g., the memory 128, the processors 124, the operating system 136, as well as other resources) of a computer platform. In an example, the host 120 is associated with an operating system (e.g., operating system 136), and the smart I/O peripheral 150 containing the failure event forecasting engine 160 manages the host 120 (e.g., predicts failure events as well as other possibly performs one or multiple other management functions) independently of the operating system of the host 120. In an example, the host 120 includes the set of measurable components that correspond to the operating behavior metrics for the computer platform 110-1. In another example, the management controller containing the failure event forecasting engine 160 may include one or multiple measurable components that provide operating behavior metrics for the computer platform 110-1.

In an example, the computer platform 110-1 is a server that has a cloud-native architecture, and the computer platform 110-1, along with the other computer platforms 110 (servers) correspond to respective domain nodes of a cloud computing system. In an example, the computer platform 110-1 provides one or multiple application operating environments 140 (e.g., bare metal environments, containers, orchestrated container clusters, virtual machines as well as other ecosystems) for one or multiple cloud tenant domains. In an example, one or multiple applications 141 may execute in each application operating environment 140.

The smart I/O peripheral 150 may take on one of many different physical forms. In an example, the smart I/O peripheral 150 is a Peripheral Component Interconnect express (PCIe) card. In another example, the smart I/O peripheral 150 is a CXL card. The smart I/O peripheral 150, in general, provides processing capability, memory and acceleration for the host 120 with the goal of supporting the delivery of a variety of higher-level services to the workloads that are executed by the host 120. The backend I/O services may be non-transparent services or transparent services. An example of a non-transparent host service is a hypervisor virtual switch offloading service using PCIe direct I/O (e.g., CPU input-output memory management unit (IOMMU) mapping of PCIe device physical and/or virtual functions) with no host control. A host transparent backend I/O service does not involve modifying host software. As examples, the transparent host services may include network-related backend I/O services for the host 120, such as overlay network services, virtual switching services, virtual routing services, network function virtualization services, encryption services and firewall-based network protection services. As examples, the transparent host services may include storage-related backend I/O services for the host 120, such as storage acceleration services (e.g., non-volatile memory express (NVMe)-based services), direct attached storage services, or Serial Attached SCSI (SAS) storage services.

In accordance with example implementations, the smart I/O peripheral 150 includes a forwarding/policy enforcement subsystem 152. In accordance with example implementations, the forwarding/policy enforcement subsystem 152 may be based on a service mesh, such as Istio. The forwarding/policy enforcement subsystem 152 collects, or aggregates, measurements of operating behavior metrics from the host 120 and provides the measurements to the failure event forecasting engine 160.

In accordance with example implementations, the failure event forecasting engine 160 may receive its configuration details from a controller 158 of the smart I/O peripheral 150, which provides control services. These control services may include setting initial tuning parameters of the failure event forecasting engine 160, such as a measurement sampling rate, profiles of measurable components of the computer platform 110-1, one or multiple detection thresholds (e.g., the SVt coefficient of sensitivity threshold, described further herein), one or multiple tolerance thresholds (e.g., the BVt behavior variance tolerance parameter, described further herein), and other and/or different tuning parameters. The initial tuning parameters may be based on user input as well as a profile of the computer platform 110-1 (e.g., a profile based on server type, network device type or model number). In another example, the configuration details specified by the control services may include identifications of specific operating behavior metrics (e.g., all available operating behavior metrics associated with all measurable components of the computer platform 110-1, or a subset thereof) of the computer platform 110-1 to be monitored by the failure event forecasting engine 160 in accordance with user preferences. In another example, failure event forecasting engine 160 may be configured, by default, to monitor a certain minimum set of operating behavior metrics (e.g., monitor all available operating behavior metrics associated with all measurable components of the computer platform 110-1 by default or monitor a certain subset of all available operating behavior metrics by default) of the computer platform 110-1, and the configuration details specified by the control services may modify the default configuration (e.g., add and/or remove monitored operating behavior metrics) in accordance with user preferences. The failure event forecasting engine 160, in accordance with example implementations, uses the control services to report failure event probability and remaining live updates to a centralized service plane (e.g., a service plane that includes the node manager 190).

Among its other features, the smart I/O peripheral 150 may include an overlay network subsystem 154 and a network interface 156 that interfaces the smart I/O peripheral 150 to the logical connections 180 and to the physical network fabric 184.

As used herein, an “engine,” such as the failure event forecasting engine 160, can refer to one or multiple circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. For the particular example implementation that is depicted in FIG. 1, the smart I/O peripheral 150 includes one or multiple hardware processors 164 (e.g., one or multiple CPU cores) and a memory 166 that stores instructions 168 that are readable by the hardware processors 164. In an example, the instructions 168 may be executed by one or multiple hardware processors 164 to cause the processor(s) 164 to perform one or multiple functions for the failure event forecasting engine 160, as described herein. Alternatively, an “engine,” in accordance with further implementations, such as the failure event forecasting engine 160, may be solely limited to one or multiple hardware processing circuits that do not execute machine-readable instructions. In another variation, the failure event forecasting engine 160 may be a combination of one or multiple hardware processing circuits and circuits that execute machine-readable instructions.

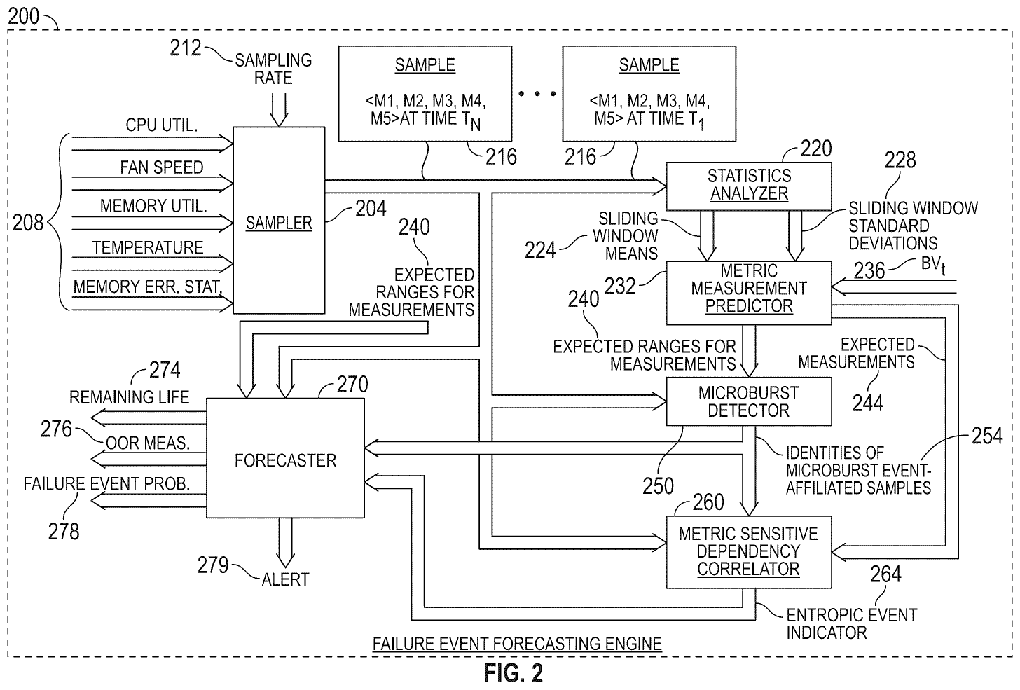

FIG. 2 depicts a block diagram of a failure event forecasting engine 200, in accordance with example implementations. The failure event forecasting engine 200, in accordance with example implementations, resides on a computer platform and predicts a failure of the computer platform. In an example, the failure event forecasting engine 200 and the computer platform correspond to the failure event forecasting engine 160 and the computer platform 110-1, respectively, of FIG. 1.

Referring to FIG. 2, in accordance with example implementations, the failure event forecasting engine 200 provides data representing a failure event probability 278 for the computer platform. The failure event forecasting engine 200 further provides data representing a remaining life 274 (e.g., a time to a failure event in terms of seconds, days or in terms of another unit of time) for the computer platform. Moreover, as depicted in FIG. 2, the failure event forecasting engine 200 provides other data related to failure event prediction and monitoring, such as data representing one or multiple out-of-range operating behavior metric measurements 276 for the computer platform. Additionally, as depicted at 279, the failure event forecasting engine 200 may provide alerts 279 to a service plane (e.g., an alert responsive to a predicted remaining life 274 of the computer platform being less than the computer platform's expected remaining life). In an example, the computer platform's remaining life may be a MTBF for a particular category or classification (e.g., a particular server model number or server category) for the computer platform.

In a broad overview of its operation, the failure event forecasting engine 200 continuously time samples a set 208 of observed operating behavior metric measurements of the computer platform and statistically analyzes the samples for purposes of determining predicted, or expected, ranges of measurements for the next sample. By comparing the actual measurements of the next sample with the corresponding expected measurement ranges, the failure event forecasting engine 200 determines whether the actual measurements of the next sample are consistent with the expected ranges. The failure event forecasting engine 200 considers a sample whose actual measurements are inconsistent with the corresponding expected ranges to correspond to a “microburst event.” Such a sample is referred to herein as a “microburst event-affiliated sample.” In the context used herein, a “microburst event” refers to the occurrence of a sample that is a statistical anomaly, in view of the statistics of prior samples.

The failure event forecasting engine's detection of a microburst event-affiliated sample triggers the engine 200 to further analyze the sample for purposes of determining whether the sample corresponds to an entropic event. In the context used herein, a sample corresponds to an “entropic event” when the operating behavior metrics of the sample fail to exhibit a minimum threshold of self-similarity. The failure event forecasting engine 200 determines whether a microburst event-affiliated sample corresponds to an entropic event by calculating a measure of self-similarity, or sensitive dependency (or “metric sensitive dependency”), for the sample and comparing the calculated sensitive dependency to a threshold.

The metric sensitivity dependency is a measure of the correlation of measurement changes associated with the microburst event-affiliated sample. In an example, a one hundred percent metric sensitive dependency means that the changes are exactly proportional to each other. A metric sensitive dependency less than one hundred percent means that the changes are not exactly proportionate, and a sensitive dependency of zero means that changes are entirely independent with respect to each other. In general, a smaller sensitive dependency corresponds to a relatively greater failure event probability for the computer platform, and a larger sensitive dependency corresponds to a relatively smaller failure event probability for the computer platform.

The failure event forecasting engine 200 determines a failure event probability for a computer platform based on the time rate of observed entropic events (e.g., the number of detected entropic events within the last five minutes) for the computer platform. Moreover, the failure event forecasting engine 200 estimates, or predicts the remaining time to a failure event (or “remaining life”) of the computer platform by determining a trend of the failure event probabilities (e.g., a trend corresponding to the determined failure event probabilities over a predefined number of most recent hours or days) and projecting the trend to a one hundred percent probability of a failure event.

Turning to the more specific details, the failure event forecasting engine 200 includes a sampler 204, which receives a set 208 of measurements of various operating behavior metrics of a computer platform. In an example, the operating behavior metric measurements may be provided by the forwarding/policy enforcement subsystem 152 of FIG. 1. The operating behavior metric measurements, in general, characterize conditions and/or states of the computer platform, and in an example that is depicted in FIG. 2, may characterize one or multiple CPU utilizations, one or multiple fan speeds, one or multiple memory utilizations, one or multiple temperatures, one or multiple memory error statistics, as well as additional and/or different measurements characterizing or indicating operating behaviors of the computer platform. In an example, the measurements 208 are normalized to a time scale and are consumption-based.

The sampler 204 may be configured with a sampling rate 212. In accordance with example implementations, the sampling rate 212 may be a configurable parameter, which serves as a tuning parameter for tuning the failure event forecasting engine's responsiveness. In an example, in accordance with some implementations, the sampler 204 may be configured with a default sampling rate 212, such as, for example, one sample per second. Increasing the sampling rate 212, in general, improves the accuracy of the failure event forecasting engine 200 in predicting computer platform failure events but increases the processing load of the failure event forecasting engine 200. Conversely, decreasing the sampling rate 212 may lower the processing load but decrease the failure event prediction accuracy.

As depicted in FIG. 2, in accordance with example implementations, the sampling by the sampler 204 produces a time sequence (or “time series”) of samples 216. Each sample 216, in accordance example implementations, is a multi-dimensional sample, where each dimension of the sample corresponds to a particular operating behavior metric of the computer platform. As represented in FIG. 2, the sample 216 may be viewed as being a vector, where the components of the vector correspond to a particular sampling time T (e.g., sampling times T₁ to T_{N} being represented in FIG. 2) and represent measurements for respective operating behavior metrics. For each example sample 216, FIG. 2 depicts an example vector <M1,M2,M3,M4,M5> that represents sampled measurements M1, M2, M3, M4 and M5, which correspond to respective dimensions (and correspondingly, respective operating behavior metrics) of the sample 216.

The failure event forecasting engine 200, in accordance with example implementations, performs a continuous statistical analysis on the samples 216. More specifically, in accordance with example implementations, a statistics analyzer 220 of the failure event forecasting engine 200 receives and statistically analyzes the time sequence of samples 216. For this purpose, the statistics analyzer 220 applies a moving, or sliding, time window to the samples 216 for purposes of calculating, for each operating behavior metric, an average, or mean 224 (also called a “sliding window mean 224” herein), and a standard deviation 228 (also called a “sliding window standard deviation 228” herein). In accordance with example implementations, the statistics analyzer 220 is configured to apply this statistical analysis to the last N samples 216 of the time series, such as for example, the example samples 216 from time T₁ to T_{N}, as depicted in FIG. 2. Stated differently, the sliding time window has a length of N samples 216. To calculate a particular set of sliding window means 224 and sliding window standard deviations 228, the statistics analyzer 220, for each operating behavior metric, calculates a sliding window mean 224 based on the measurement of the metric in the current (or most recent) sample 216 and the N-1 samples 216 that immediately precede the current sample 216.

A metric measurement predictor 232 of the failure event forecasting engine 200 uses the sliding window means 224 and the sliding window standard deviations 228 to predict expected measurements 244 for the next sample and also predict expected ranges 240 for the next sample 216. In this context, the “next sample” refers to a sample 216 that proceeds (in time) the sliding time window. In an example, the next sample 216 may be a future sample 216 (at the time of the statistics calculations) that is to be sampled at the next sampling time. In an example, the next sample 216 may be a “current sample,” which is the sample acquired at the most recent sampling time.

The statistic analyzer's calculation of the sliding window mean 224 for each operating behavior metric may be described as follows:

$$μ = \frac{1}{N} {\sum }_{i = 1}^{N} {x}_{i} , \qquad Eq . 1$$

where “μ” represents the sliding time window mean 224, “N” represents the number of samples within the sliding time window, and “xᵢ” represents the measurement of the operating behavior metric indexed to a particular sample 216 within the sliding time window. The statistics analyzer's calculation of the sliding window standard deviation 228 (represented by “σ”) may be described as follows:

$$σ = \sqrt{\frac{\sum {( {x}_{i} - μ )}^{2}}{N}} . \qquad Eq . 2$$

The sliding window means 224 and sliding window standard deviations 228 are received by the metric measurement predictor 232. For purposes of determining the expected ranges 240, the metric measurement predictor 232 may be configured with a behavior variation tolerance tuning parameter (called the “BVt parameter 236” herein). In accordance with example implementations, the metric measurement predictor 232 calculates a predicted coefficient of variation (called “CVₚ” herein) for each metric. The CVₚ predicted coefficient of variation represents a predicted variation of the corresponding metric measurement from the moving standard deviation of the corresponding N samples 216 of the sliding window. The metric measurement predictor's calculation of the CVₚ predicted coefficient of variation may be described as follows in Eq. 3:

$${CV}_{p =} \frac{1}{N} {\sum }_{i = 1}^{N} \frac{σ}{μ} . \qquad Eq . 3$$

Using the CVₚ predicted coefficient of variation, the metric measurement predictor 232 may then calculate, for each expected range 240, a predicted lower boundary (called “LBₚ” herein) and a predicted upper boundary (called “UBₚ” herein). In accordance with example implementations, the metric measurement predictor 232 calculates the LBₚ predicted lower boundary by decreasing the moving average (the mean) by one half of the CVₚ predicted coefficient of variation and decreasing the result by the BVt behavior variation tolerance, as described below in Eq. 4:

$${LB}_{p} = ( 1 - \frac{{CV}_{P}}{2} ) μ ( 1 - {BV}_{t} ) . \qquad Eq . 4$$

In accordance with example implementations, the metric measurement predictor 232 calculates the UBₚ predicted upper boundary by increasing the moving average by one half of the CVₚ predicted coefficient of variation and increasing the result by the BVt behavior variation tolerance, as described below in Eq. 5:

$${UB}_{p} = ( 1 + \frac{{CV}_{P}}{2} ) μ ( 1 + {BV}_{t} ) . \qquad Eq . 5$$

A microburst detector 250 of the failure event forecasting engine 160 determines whether the current sample 216 is a microburst-affiliated sample and therefore, corresponds to a microburst event. More specifically, the microburst detector 250 compares the actual measurements of the current sample 216 to the expected ranges 240 for the sample 216. Stated differently, the microburst detector 250, for each measurement, determines whether the measurement is greater than the UBₚ predicted lower measurement boundary or less than the LBₚ predicted lower measurement boundary.

The microburst detector 250 determines, based on the comparisons, whether the actual measurements of the current sample 216 are consistent with the expected ranges 240. In this context, the actual measurements being “consistent with” the expected ranges refers to a comparison of the actual measurements meeting a predefined criterion. In an example, the predefined criterion may be that all of the actual measurements of the current sample are to be within the corresponding expected ranges for consistency, and the microburst detector 250 may determine, for example, that actual measurements are inconsistent with the expected ranges if at least one of the actual measurements falls outside of the corresponding expected range. In another example, the predefined criterion may be that a certain number (e.g., two) of the actual measurements are to be within the corresponding expected ranges for consistency.

In accordance with example implementations, if the microburst detector 250 determines that the measurements of the current sample 216 are inconsistent with the expected ranges 240 for the current sample 216, then the microburst detector 250 labels, or flags, the current sample 216 as being a microburst event-affiliated sample 216. As depicted at 254, the microburst detector 250 provides data identifying microburst event-affiliated samples to a metric sensitive dependency correlator 260 of the failure event forecasting engine 200.

The metric sensitive dependency correlator 260 analyzes microburst event-affiliated samples 216 for purposes of making the further determination of whether or not the samples 216 correspond to respective entropic events. For this analysis, the metric sensitive dependency correlator 260, in accordance with example implementations, calculates an actual coefficient of variation (called “CVₐ” herein) for each measurement of a microburst event-affiliated sample 216. The CVₐ actual coefficient of variation represents a change of the actual measurement to a corresponding predicted measurement. More specifically, in accordance with some implementations, the metric sensitive dependency correlator 260 may calculate the CVₐ actual coefficient of variation for a given measurement as described below in Eq. 6:

$${CV}_{a} = \frac{{x}_{a}}{{x}_{p}} - 1 , \qquad Eq . 6$$

where “xₐ” represents the actual measurement, and “xₚ” represents the predicted measurement. As an example, the predicted measurement may be the corresponding mean that is determined from the sliding window. In the absence of an entropic event, the CVₐ actual coefficients of variations for a microburst-affiliated sample 216 should be similar, or close in value. Stated differently, in the absence of an entropic event, the measurements of the sample 216 vary approximately proportionally the same.

In accordance with example implementations, the metric sensitive dependency correlator 260 quantifies when the CVₐ coefficients of variation are deemed to be close or are far apart enough to be considered associated with an entropic event using a coefficient of sensitivity (herein called “CS” herein). More specifically, in accordance with some implementations the metric sensitive dependency correlator 260 may calculate the CS coefficient of sensitivity as described below in Eq. 7:

$$CS = MAX ( {CV}_{a} ) - MIN ( {CV}_{a} ) , \qquad Eq . 7$$

where “MAX(CVₐ)” represents the maximum of the CVₐ actual coefficients of variation, and “MIN(CVₐ)” represents the minimum of the CVₐ actual coefficients of variation. Stated differently, the CS coefficient of sensitivity, in accordance with example implementations, represents the range of the CVₐ actual coefficients of variation.

In accordance with example implementations, the metric sensitive dependency correlator 260 may compare the CS coefficient of sensitivity to a threshold (called “SV” herein) for purposes of determining whether or not the sample 216 corresponds to an entropic event. More specifically, in accordance with some implementations, the metric sensitive dependency correlator 260 may, for example, determine that a microburst event-affiliated sample 216 corresponds to an entropic event in response to the CS coefficient of sensitivity being greater than the SVt threshold.

In accordance with example implementations, the metric sensitive dependency correlator 260 provides an entropic event indicator 264 representing whether or not a particular microburst event-affiliated sample corresponds to an entropic event. A sample 216 that corresponds to an entropic event is referred to herein as an “entropic event-affiliated sample 216.” A forecaster 270 of the failure event forecasting engine 200 is notified about detected entropic events by the entropic event indicator 264. The forecaster 270 also receives, for each entropic event-affiliated sample, data representing the actual measurements of the sample 216 and the expected ranges 240 for the sample 216.

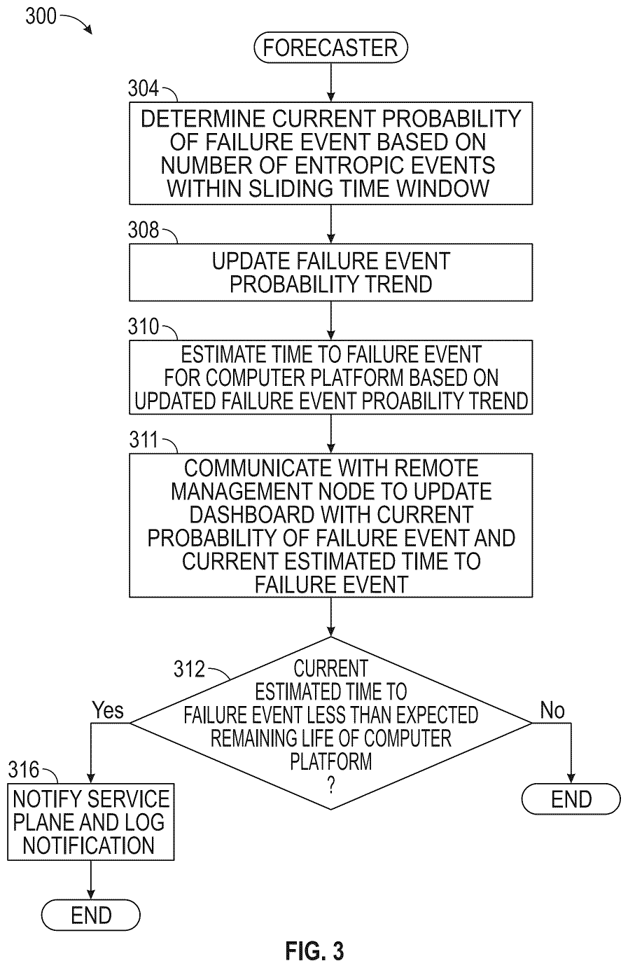

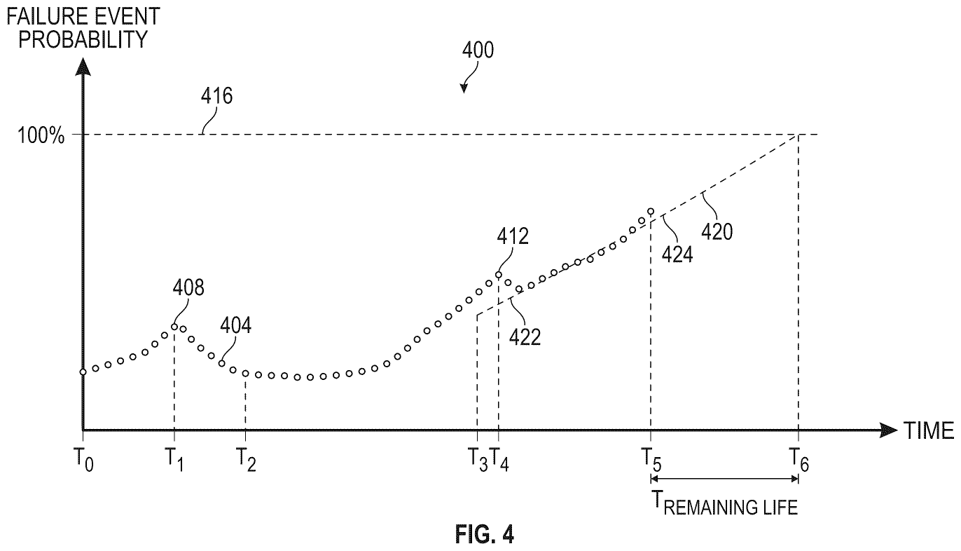

As further described herein in connection with FIGS. 3 and 4, the forecaster 270 determines a failure event probability 278 based on a time rate of detected entropic events, and the forecaster 270 predicts a remaining life 274 of the computer platform based on a trend of determined failure event probabilities 278. Moreover, in accordance with example implementations, the forecaster 270 provides alerts 279 and data representing out-of-range measurements 276 to a service plane (e.g., alerts to a management node, such as the management node 190 of FIG. 1).

The forecaster 270, in accordance with example implementations, reports out-of-range measurements 276, which may be beneficial, even when the corresponding sample 216 is not considered to be an entropic event or even a microburst event. For example, a particular measurement (e.g., a fan speed or a temperature) may be out-of-range and may warrant further investigation, although the particular out-of-range measurement may itself may not be affiliated with a particular failure of the computer platform. In accordance with some implementations, the forecaster 270 monitors the output of the microburst detector 250 for purposes being alerted to out-of-range measurements.

FIG. 3 depicts a technique 300 to determine a failure event probability for a computer platform and estimate a time to a failure event, in accordance with example implementations. In an example, a forecaster, such as the forecaster 270 of FIG. 2, performs the technique 300 responsive to the detection of an entropic event, such as detection of an entropic event by the metric sensitive dependency correlator 260 of FIG. 2.

Referring to FIG. 3, the technique 300 includes determining (block 304) a current probability of a failure event for a computer platform based on the number of detected entropic events within a moving, or sliding, time window (e.g., a time window of five minutes). In an example, the sliding time window may have one time boundary corresponding to the most recent operating behavior measurement sampling time and extend back in time by a predetermined number Y of sampling intervals, which corresponds to the length, or duration, of the sliding time window. Continuing the example, within the sliding window, the forecaster counts a certain number G of detected entropic events, and the forecaster determines the current probability of a failure event by dividing the G number of entropic events by the number Y of sampling intervals in the sliding time window, or G/Y. In an example, the failure event probability may be “G/Y.” In another example, the failure event probability may be derived from “G/Y,” such as a failure event probability that is proportional to “G/Y,” or another value derived from “G/Y.”

In an example, the forecaster determines a new failure event probability for every sampling interval. In another example, the forecaster determines a new failure event probability less often (e.g., for every other sampling interval or at another subinterval of the sliding time window). In another example, the forecaster determines a new failure event probability in response to the detection of a new entropic event. Regardless of the policy for updating the failure event probability, the probability changes over time, and in general, the failure event probability for a computer platform increases over time.

The forecaster, in accordance with example implementations, uses a history of failure event probabilities to predict, or estimate, the remaining life of the computer platform. For this purpose, the technique 300 includes updating (block 308) a failure event probability trend for the computer platform and predicting, or estimating (block 310), a remaining life for the computer platform based on the updated failure event probability trend. In this context, a failure event probability “trend” refers to a general direction for a most recent set of determined failure event probabilities. In an example, a failure event probability trend is a line of monotonically increasing failure event probabilities. In another example, a failure event probability trend is nonlinear, or a curve. In an example, the forecaster determines the failure event probability trend based on the most recent F probabilities. In an example, the forecaster may determine the failure event probability trend using a curve fitting algorithm (e.g., a linear regression algorithm, a polynomial regression algorithm or other algorithm to characterize the probabilities) that is applied backwards in time over a certain sliding time window.

In accordance with example implementations, the technique 300 includes estimating the time to a failure event, pursuant to block 310, by projecting, or extrapolating, the probability trend to a one hundred percent probability of failure. The one hundred percent probability of failure corresponds to a particular predicted future time of failure, and the remaining life is the difference between the future time of failure and the current time.

As depicted in block 311, the technique 300 includes communicating with a remote management node (e.g., the remote management node 190 of FIG. 1) for purposes of updating a GUI (e.g., a dashboard) of the management node with the current estimated failure event probability and the current estimated time to a failure event. The remaining life for a given computer platform is generally expected to decrease over time. Accordingly, a decreasing remaining life is not by itself a cause for alarm, and system administrators may monitor remaining lives for computer platforms for purposes of formulating and enacting plans to service and replace the computer platforms. However, the predicted remaining life for a particular computer platform may be sooner than expected. In this context, an “expected” remaining life for a computer platform refers to a remaining time that is calculated by useful life statistics for the computer platform, such as a remaining life that is consistent with a MTBF for the computer platform.

Pursuant to decision block 312, the technique 300 includes determining whether the current estimated remaining life for the computer platform is less than expected, and if so, the technique 300 includes notifying the service plane and logging the notification, as depicted in block 316. In an example of a notification, the forecaster communicates with a dashboard of a remote management node, which causes the remote management node to display an alert message for the computer platform. In another example of a notification, the forecaster sends a message (e.g., an email, SMS text or other notification) to a system administrator. In another example of a notification, the forecaster causes an LED, display screen or other indicator on the computer platform or a structure (e.g., a rack) associated with the computer platform to display a corresponding visual alert indicator.

FIG. 4 is an illustration 400 of a technique to estimate the remaining life of a computer platform (i.e., the time to a failure event) based on a history of determined failure event probabilities. In an example, the remaining estimation technique illustrated in FIG. 4 may be performed by a forecaster, such as the forecaster 270 of FIG. 2.

FIG. 4 depicts a graph 404 of a failure event probability. The graph 404 is a time profile of estimated failure event probabilities over an exemplary time interval that spans from a particular time T₀ to a time T₅ (the current time). Although the failure event probabilities for a computer platform generally increase over time, there may be times in which the failure event probability momentarily decreases. For example, the computer platform may have a temperature that momentarily exceeds an expected temperature range and may correspondingly lead to multiple entropic events occurring in a short interval of time and result in a failure event probability peak, such as the exemplary probability peak 408 in the graph 404 at time T₁. The temperature anomaly may be caused by a temporary condition (e.g., a momentary cooling airflow obstruction or a momentary fan malfunction), which resolves itself to allow the temperature to return to an expected range. The temperature returning to the expected range decreases the failure event probability, as indicated in the portion of the probability graph 404 from time T₁ to time T₂. For this example, due to the time rate of entropic events once again increasing (e.g., the condition causing the previous temperature rise reoccurring or due to one or multiple other reasons), the failure event probability increases, as depicted in the portion of the probability graph 404 from time T₂ to time T₄. FIG. 4, depicts the failure event probability again decreasing after time T₄ for a short time before again rising to the current failure event probability at time T₅.

For this example, the forecaster applies a linear regression algorithm (e.g., a least squares regression algorithm) to derive a segment 422 of a trend line 420. The trend line segment 422 approximates the more recent trend of failure event probabilities. In an example, the trend line segment 422 may correspond to a line described by the equation “Failure Event Probability=mt+b” (where “m” represents the slope, and “b” represents the y-offset) spanning from time T₃ to time T₅. As also depicted in FIG. 4, the trend line 420 further includes an extrapolated segment 424, which extends from the current time T₅ to a future time T₆, which corresponds to a one hundred percent failure event probability (as represented by horizontal line 416). A time difference (labeled “T_{REMAINING LIFE}” in FIG. 4) between the estimated failure time T₆ and the current time T₅ corresponds to the estimated remaining life of the computer platform. In an example, the forecaster may determine the predicted failure time T₆ as follows:

$$Time {T}_{6} = \frac{100 - b}{m} , \qquad Eq . 8$$

where “b” represents the y-intercept of the trend line 420, and “m” represents the slope of the trend line 420.

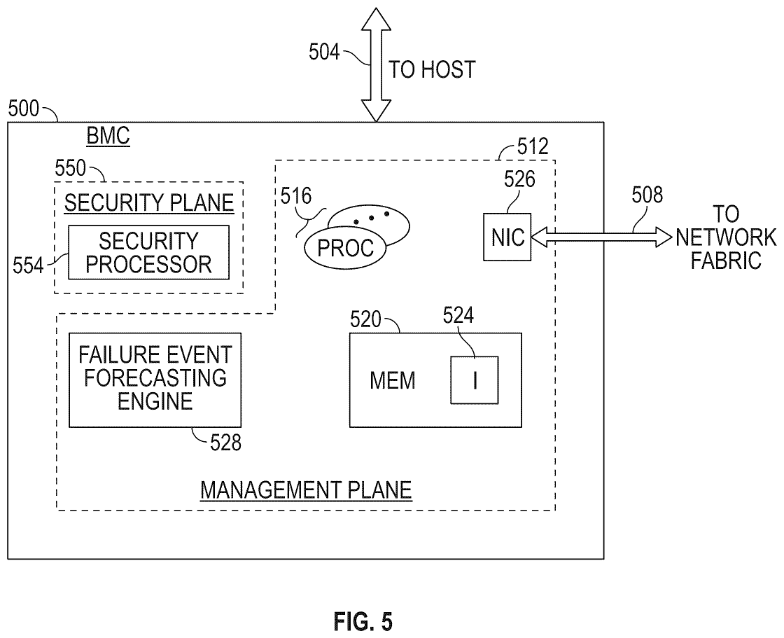

The failure event forecasting engine may be provided by a management controller of the computer platform other than a smart I/O peripheral, in accordance with further implementations. For example, referring to FIG. 5, in accordance with some implementations, a failure event forecasting engine 528 for a computer platform may be provided by a baseboard management controller 500 of the computer platform.

As used herein, a “baseboard management controller,” or “BMC,” is a specialized service processor that monitors the physical state of a server or other hardware using sensors and communicates with a management system through a management network. The baseboard management controller may communicate with applications executing at the operating system level through an input/output controller (IOCTL) interface driver, a representational state transfer (REST) application program interface (API), or some other system software proxy that facilitates communication between the baseboard management controller and applications. The baseboard management controller may have hardware level access to hardware devices of the host of the computer platform, including system memory. The baseboard management controller may be able to directly modify the hardware devices. The baseboard management controller may operate independently of the operating system of the computer platform. The baseboard management controller may be located on the motherboard or main circuit board of the computer platform.

The fact that a baseboard management controller is mounted on a motherboard of the computer platform or is otherwise connected or attached to the computer platform does not prevent the baseboard management controller from being considered “separate” from the host of the computer platform. As used herein, a baseboard management controller has management capabilities for sub-systems of a computer platform and is separate from the processing resources that execute an operating system of the computer platform.

The baseboard management controller 500 may provide various management services for the computer platform as part of the baseboard management controller's management plane 512. In examples, the management services include collecting operating behavior metric measurements of the host for the failure event forecasting engine 528; monitoring sensors (e.g., temperature sensors, cooling fan speed sensors) of the host; monitoring an operating system of the host; monitoring a power status of the host; logging computer platform events; providing remotely-controlled management functions for the computer platform; and so forth.

The management plane 512 may include one or multiple hardware processors 516 (e.g., CPU cores) that execute machine-readable instructions 524 that are stored in a memory 524 of the baseboard management controller 500. In an example, the instructions 524 may correspond to a management stack for the baseboard management controller 500. In another example, the instructions 524, when executed by one or multiple hardware processors 516 form the failure event forecasting engine 528. In accordance with further implementations, the failure event forecasting engine 528 may be formed in whole or in part by dedicated hardware circuitry (e.g., a PLD, an ASIC or an FPGA).

The baseboard management controller 500, in accordance with some implementations, may further provide a security plane 550, which is isolated (e. g., protected by a cryptographic boundary) from its management plane 512. As part of the security plane 550, a security processor 554 of the baseboard management controller 500 may provide various security services (e.g., secure storage for cryptographic security parameters, cryptographic services, cryptographic key sealing and unsealing, and other security services) for the computer platform. In accordance with some implementations, the security plane 550 may contain a silicon root-of-trust engine, which corresponds to the hardware root of the chain of trust for the computer platform. The silicon root-of-trust engine, in accordance with some implementations may, in response to the power up or reset of the computer platform, measure, load and execute initial security service-related firmware for the baseboard management controller 500 to begin a measured boot.

Among its other features, the baseboard management controller 500 may include one or multiple host controller interfaces for purposes of providing host APIs to communicate with the host, as depicted at 504. Moreover, as depicted at 508, the baseboard management controller 500 may include a network interface controller 526 for purposes of communicating with a remote management server (e.g., the management node 190 of FIG. 1).

Other variations are contemplated, which are within the scope of the appended claims. For example, in accordance with further implementations, a failure event forecasting engine may not be located on a computer platform whose failure is predicted by the engine. In an example, a blade server of a rack may contain a failure event forecasting engine that predicts failure of the blade server and predicts failures of one or multiple other blade servers of the rack. In another example, a router may contain a failure event forecasting engine that predicts failures of network devices within a certain local network branch. In another example, a chassis management controller of a rack may contain a failure event forecasting engine that predicts failures of computer platforms (e.g., servers and/or network devices) that are located in the rack.

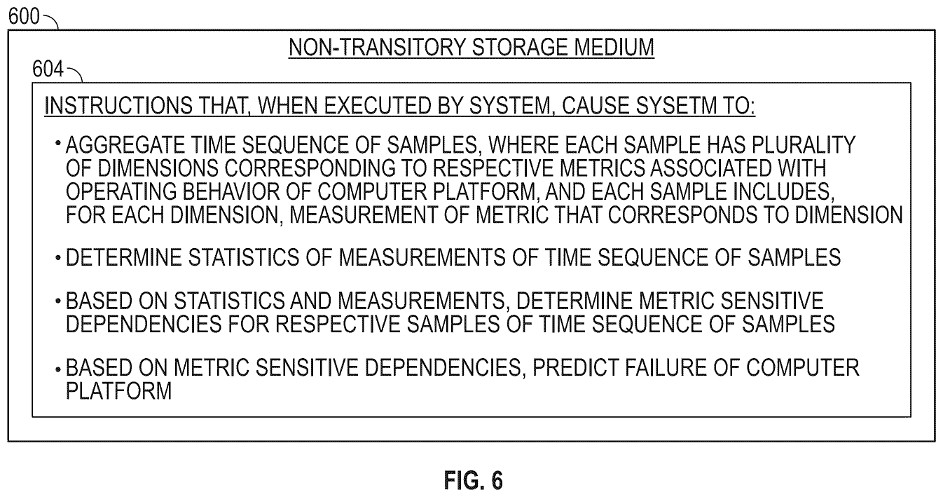

Referring to FIG. 6, in accordance with example implementations, a non-transitory storage medium 600 stores instructions 604 that are readable by a system. In examples, the system may be a management controller, such as a baseboard management controller or a smart I/O peripheral. In an example, the instructions 604 may be executed by one or multiple hardware processors of the management controller. The instructions 604, when executed by the system, cause the system to aggregate a time sequence of samples. Each sample has a plurality of dimensions that correspond to respective metrics that are associated with an operating behavior of a computer platform. In an example, the computer platform may contain a management controller that executes the instructions 604. Each sample includes, for each dimension, a measurement of the metric that corresponds to the dimension. In an example, the measurements may characterize states or conditions of a host of the computer platform. In examples, the measurements may characterize one or multiple of a CPU utilization, a memory utilization, a memory error statistic, a fan speed, a temperature, or another state or condition associated with the computer platform.

The instructions 604, when executed by the system, further cause the system to determine statistics of the measurements of the time sequence of samples. In an example, the statistics may include, for each dimension, a mean and a standard deviation. In an example, the statistics may include, for each dimension, a predicted coefficient of variation for the next sample of the time sequence of samples. In an example, for each dimension, the predicted coefficient of variation may be based on a mean and a standard deviation determined from the samples.

The instructions 604, when executed by the system, further cause the system to determine metric sensitive dependencies for respective samples of the time sequence of samples. In an example, the sensitive dependency is a measure of the self-similarity of the measurements according to the mathematical chaos theory. In an example, the determination of the sensitive dependency may include determining actual coefficients of variation of the measurements of the given sample, and setting a coefficient of sensitive dependency equal to the span between the maximum and minimum of the actual coefficients of variation.

The instructions 604, when executed by the system, further cause the system to predict a failure of the computer platform based on the sensitive dependency. In an example, predicting the failure includes determining a probability of a failure event for the computer platform. In an example, predicting the failure includes estimating a remaining life of the computer platform. In an example, predicting failure of the computer platform includes determining a trend for determined probabilities of failure for the computer platform. In an example, predicting the failure includes extending the trend to a one hundred percent failure, and estimating a remaining life based on a time of the one hundred percent failure and the current time.

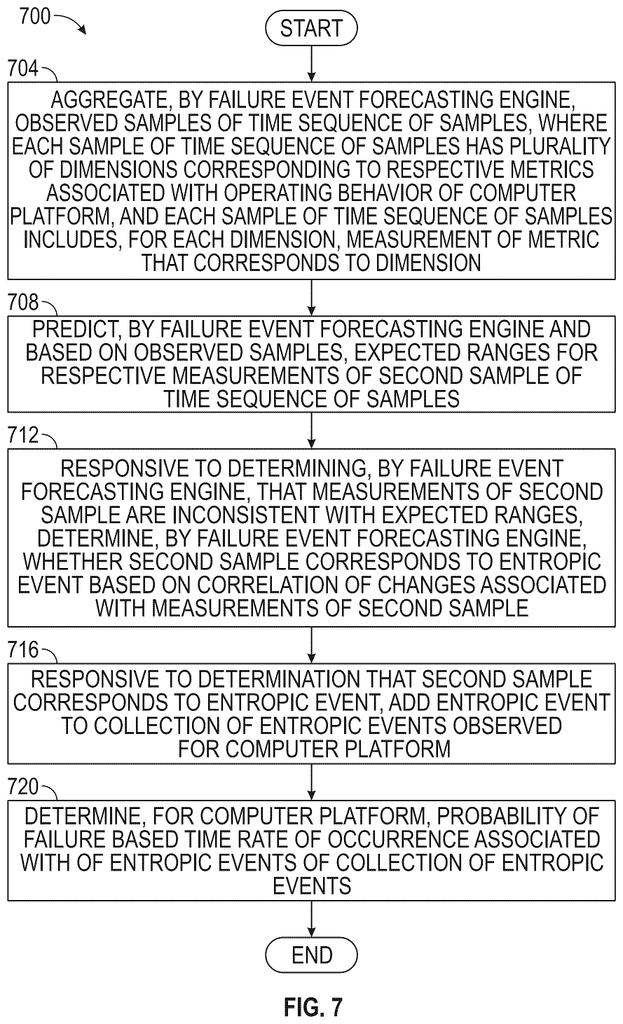

Referring to FIG. 7, in accordance with example implementations, a technique 700 includes aggregating (block 704), by a failure event forecasting engine, observed samples of a time sequence of samples. Each sample has a plurality of dimensions corresponding to respective metrics associated with an operating behavior of a computer platform. Each sample includes, for each dimension of the plurality of dimensions, a measurement of the metric that corresponds to the dimension. In an example, the measurements may characterize one or multiple of a CPU utilization, a memory utilization, a fan speed, a memory error statistic, a temperature, or another state or condition of the computer platform. In an example, the measurements may be associated with a host of the computer platform.

In an example, the failure event forecasting engine may be a component of a smart I/O peripheral of the computer platform. In another example, the failure event forecasting engine may be provided by a baseboard management controller of the computer platform.

The technique 700 includes predicting (block 708), by the failure event forecasting engine and based on the observed samples, expected ranges for respective measurements of a second sample. In an example, the expected ranges may be based on statistics (e.g., a mean, a standard deviation, and a coefficient of variation) that are calculated for each metric based on a sliding window (e.g., the measurements corresponding to the last N samples) of observed measurements. In an example, an expected range for a particular dimension may be calculated based on a mean and a coefficient of variation. In an example, upper and lower boundaries of an expected range may be modulated by a behavior variation tolerance.

The technique 700 includes, pursuant to block 712, responsive to determining, by the failure event forecasting engine, that measurements of the second sample are inconsistent with the expected ranges, determining, by the failure event forecasting engine, whether the second sample corresponds to an entropic event based on a correlation of changes associated with the measurements of the second sample. In an example, an entropic event is an occurrence corresponding to a sample having one or multiple measurements that are inconsistent with statistics observed from other samples. In an example, an entropic event may be an occurrence corresponding to one or multiple measurements of a sample being outside of expected ranges for the measurements.

In an example, the changes may be represented by corresponding actual coefficients of variation. In an example, correlating the changes includes determining a sensitive dependency among the metrics. In an example, determining a sensitive dependency includes evaluating a range of the actual coefficients of variation. In an example, evaluating the range of the actual coefficients of variation includes determining a minimum of the actual coefficients of variation, determining a minimum of the coefficients of variation, and determining a difference of the maximum and the minimum. In an example, the difference of the maximum and the minimum represents a coefficient of sensitivity. In an example, determining whether the second sample corresponds to an entropic event includes comparing the coefficient of sensitivity to a threshold.

Pursuant to block 716, the technique includes, responsive to the determination that the second sample corresponds to an entropic event, adding (block 716), by the failure event forecasting engine, the entropic event to a collection of entropic events that are observed for the computer platform. The technique 700 includes, pursuant to block 720, determining, for the computer platform, a probability of failure based on a time rate of occurrence of entropic events. In an example, determining the time rate of occurrence of entropic events includes the failure of the event forecasting engine counting the number of entropic events that have been detected within a sliding time window.

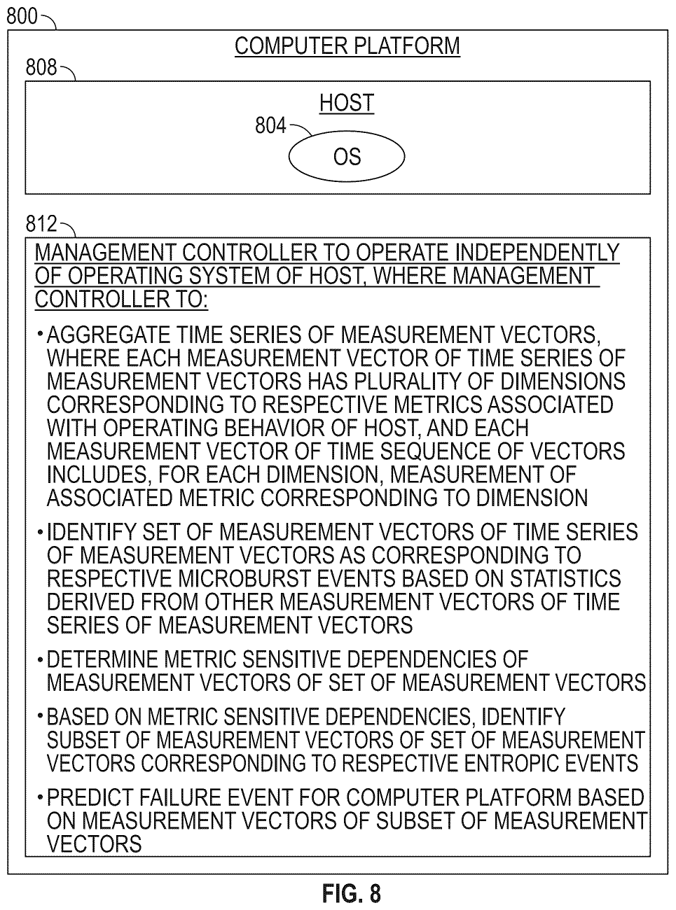

Referring to FIG. 8, in accordance with example implementations, a computer platform 800 includes a host 804 and a baseboard management controller 808. In an example, the host 804 may include one or multiple CPU processing cores or one or multiple GPU processing cores. In an example, the computer platform 800 may be a server. In another example, the computer platform 800 may be a network device.

In an example, the management controller 812 may include one or multiple circuits. In an example, the circuits may be hardware processing circuits, which can include any or some combination of a microprocessor, a core of a multi-core microprocessor, a microcontroller, a programmable integrated circuit, a programmable gate array, an ASIC, or another hardware processing circuit. In an example, the management controller 812 may include one or multiple processors that execute machine-readable instructions to perform one or multiple functions for the management controller 812. In an example, the management controller 812 may include one or multiple hardware processing circuits that do not execute machine-readable instructions or a combination of one or multiple such hardware processing circuits and circuits that execute machine-readable instructions. In an example, the management controller 812 may be a baseboard management controller. In another example, the management controller 812 may be a smart I/O peripheral.

The management controller 812 aggregates a time series of measurement vectors. Each measurement vector has a plurality of dimensions corresponding to respective metrics associated with operating behavior of the host 808. Each measurement vector includes, for each dimension, a measurement of the associated metric corresponding to the dimension. In an example, the measurements may include one or more of the following: a CPU utilization, a memory utilization, a fan speed, a memory error statistic, a temperature, or another state or condition of the computer platform.

The management controller 812 identifies a given measurement vector based on statistics, which are derived from other measurement vectors. In an example, the statistics may include, for each dimension, a mean, a standard deviation, and a coefficient of variation, and the management controller 812 may calculate the statistics based on a sliding window corresponding to the last N measurement vectors. In an example, the management controller 812 may identify the given measurement vector by determining that one or multiple measurements of the given measurements are unexpected according to the statistics. In an example, a measurement being unexpected corresponds to the measurement falling outside of an expected range derived from a mean, a standard deviation and a coefficient of variation calculated from other measurements of the same dimension.

The management controller 812 determines coefficients of variations of the measurements of the given measurement vector. In an example, the coefficients of variation may be actual coefficients of variation. The management controller 812 determines metric sensitive dependencies of measurement vectors of the set of measurement vectors. In an example, the sensitive dependency may be represented by a coefficient of sensitivity. In an example, the management controller 812 may determine the coefficient of sensitivity by determining a minimum of actual coefficients of variation, determining a maximum of actual coefficients of variation, and determining a difference of the maximum and minimum. In an example, the sensitive dependency may represent a measure of self-similarity of the metrics.

The management controller 812 predicts a failure event for the computer platform based on measurement vectors of the subset of measurement vectors. In an example, the management controller 812 determines a time rate of entropic events that are identified using the sensitive dependencies, and determines a probability for the failure event based on the time rate. In an example, the management controller 812 counts the number of identified entropic events occurring within a sliding time window and predicts a failure event probability based on the count. In an example, the management controller 812 predicts a remaining life of the computer platform. In an example, predicting the remaining life includes the management controller 812 determining a trend of determined failure event probabilities and extrapolating the trend to a future time corresponding to a one hundred percent failure for the computer platform.

In accordance with example implementations, first samples of the time sequence of samples are identified based on the metric sensitive dependencies. The first samples correspond to entropic events. A probability of a failure event is predicted based on a time rate of the entropic events. Among the potential advantages, failure events for computer platforms are accurately detected in real time or near real time and account for nuances of the computer platforms.

In accordance with example implementations, entropic events are time averaged over respective time windows to provide respective time rates of entropic events. The time rates correspond to respective failure probabilities. A trend is determined based on the failure probabilities, and a time to a failure event is predicted based on the trend. Among the potential advantages, failure events for computer platforms are accurately detected in real time or near real time and account for nuances of the computer platforms.

In accordance with example implementations, based on the statistics, expected ranges for the measurements are determined; and based on the expected ranges and the measurements, a set of samples are identified corresponding to microbursts. Responsive to identifying the set of samples as corresponding to microbursts, a metric sensitivity for each sample is determined; and based on the metric sensitive dependencies, respective samples are identified as corresponding to entropic events. Among the potential advantages, failure events for computer platforms are accurately detected in real time or near real time and account for nuances of the computer platforms.

In accordance with example implementations, the statistics include means and standard deviations. Among the potential advantages, failure events for computer platforms are accurately detected in real time or near real time and account for nuances of the computer platforms.

In accordance with example implementations, boundaries defining the expected ranges are determined based on a tuning parameter. Among the potential advantages, failure events for computer platforms are accurately detected in real time or near real time and account for nuances of the computer platforms.

In accordance with example implementations, the computer platform is a server or a network device. Among the potential advantages, failure events for computer platforms are accurately detected in real time or near real time and account for nuances of the computer platforms.

In accordance with example implementations, the metrics include at least one of a CPU utilization of the computer platform, a memory utilization of the computer platform, a temperature of the computer platform, a fan speed of the computer platform, or a memory error statistic of the computer platform. Among the potential advantages, failure events for computer platforms are accurately detected in real time or near real time and account for nuances of the computer platforms.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A non-transitory machine-readable storage medium that stores instructions that, when executed by a system, cause the system to:
aggregate a time sequence of samples, wherein each sample of the time sequence of samples has a plurality of dimensions corresponding to respective metrics associated with an operating behavior of a computer platform, and each sample of the time sequence of samples comprises, for each dimension of the plurality of dimensions, a measurement of the metric that corresponds to the dimension;
determine statistics of the measurements of the time sequence of samples;
based on the statistics and the measurements, determine metric sensitive dependencies for respective samples of the time sequence of samples; and
based on the metric sensitive dependencies, predict a failure of the computer platform.

2. The storage medium of claim 1, wherein the instructions, when executed by the system, further cause the system to:
based on the metric sensitive dependencies, identify first samples of the time sequence of samples as corresponding to entropic events; and
predict a probability of a failure event associated with the computer platform based on a time rate of the entropic events.

3. The storage medium of claim 1, wherein the instructions, when executed by the system, further cause the system to:
based on the metric sensitive dependencies, identify first samples of the time sequence of samples as corresponding to entropic events;
time average the entropic events over respective time windows to provide respective time rates of entropic events, wherein the time rates correspond to respective failure probabilities;
determine a trend based on the failure probabilities; and
predicting a time to a failure event associated with the computer platform based on the trend.

4. The storage medium of claim 1, wherein the instructions, when executed by the system, further cause the system to:
determine, based on the statistics, expected ranges for the measurements; and
based on the expected ranges and the measurements, identify a set of samples of the time sequence of samples as corresponding to microbursts;
responsive to identifying the set of samples as corresponding to microbursts, determine a metric sensitivity for each sample of the set of samples; and
based on the metric sensitive dependencies determined for the samples of the set of samples, identify the respective samples as corresponding to entropic events.

5. The storage medium of claim 4, wherein the statistics comprise means and standard deviations.

6. The storage medium of claim 4, wherein the instructions, when executed by the system, further cause the system to further determine boundaries defining the expected ranges based on a tuning parameter.

7. The storage medium of claim 1, wherein the computer platform comprises a server or a network device.

8. The storage medium of claim 1, wherein the metrics comprise at least one of a CPU utilization of the computer platform, a memory utilization of the computer platform, a temperature of the computer platform, a fan speed of the computer platform, or a memory error statistic of the computer platform.

9. A method comprising:
aggregating, by a failure event forecasting engine, observed samples of a time sequence of samples, wherein each sample of the time sequence of samples has a plurality of dimensions corresponding to respective metrics associated with an operating behavior of a computer platform, and each sample of the time sequence of samples comprises, for each dimension of the plurality of dimensions, a measurement of the metric that corresponds to the dimension;
predicting, by the failure event forecasting engine and based on the observed samples, expected ranges for respective measurements of a second sample of the time sequence of samples;
responsive to determining, by the failure event forecasting engine, that the measurements of the second sample are inconsistent with the expected ranges, determining, by the by the failure event forecasting engine, whether the second sample corresponds to an entropic event based on a correlation of changes associated with the measurements of the second sample; and
responsive to the determination that the second sample corresponds to an entropic event, adding the entropic event to a collection of entropic events observed for the computer platform; and
determining, for the computer platform, a probability of failure based on an average time rate of occurrence associated with the entropic events of the collection of entropic events.

10. The method of claim 9, further comprising:
defining time boundaries of a sliding time window; and
identifying the entropic events of the collection of entropic events based on whether times associated with the entropic events are within the time boundaries.

11. The method of claim 9, further comprising:
adding the probability of failure to a collection of probabilities of failure determined over an interval of time;
determining a time trend based on the collection of probabilities of failure; and
based on the time trend, determining a time to a failure event for the computer platform.

12. The method of claim 11, wherein determining the time to the failure event comprises determining a time between a current time and a time associated with a one hundred percent probability of failure.

13. The method of claim 12, further comprising:
generating an alert responsive to the remaining time to the failure event being less than a remaining time based on an expected lifetime of the computer platform.

14. The method of claim 9, wherein determining whether the second sample corresponds to an entropic event further comprises:
determining a metric sensitive dependency based on the correlations of changes of the second sample;
comparing the metric sensitive dependency to a threshold; and
identifying the second sample as corresponding to an entropic event based on a result of the comparison.

15. A computer platform comprising:
a host associated with an operating system; and
a management controller to manage the host independently from the operating system, wherein the management controller to:
access a time series of measurement vectors, wherein each measurement vector of the time series of measurement vectors has a plurality of dimensions corresponding to respective metrics associated with an operating behavior of the host, and each measurement vector of the time sequence of vectors comprises, for each dimension of the plurality of dimensions, a measurement of the associated metric corresponding to the dimension;
identify a set of measurement vectors of the time series of measurement vectors as corresponding to respective microburst events based on statistics derived from other measurement vectors of the time series of measurement vectors;
determine metric sensitive dependencies of the measurement vectors of the set of measurement vectors;
based on the metric sensitive dependencies, identify a subset of measurement vectors of the set of measurement vectors corresponding to respective entropic events; and
predict a failure event for the computer platform based on the measurement vectors of the subset.

16. The computer platform of claim 15, wherein the management controller comprises one of a baseboard management controller or a smart input/output (I/O) peripheral.

17. The computer platform of claim 15, wherein the management controller to:
determine, based on a time rate of the entropic events, a probability of the failure event.

18. The computer platform of claim 17, wherein the management controller to:
select a subset of entropic events responsive to the entropic events of the subset being associated with respective times that corresponding to a sliding time window, wherein the sliding time window corresponds to a first number of sampling times of the time series of measurement vectors; and
determine the probability based on the first number and a second number of the entropic events of the subset.

19. The computer platform of claim 15, wherein the management controller to:
identifying different groups of the entropic events corresponding to different time positions of a sliding time window;
for each time position of the different time positions of the sliding time window, determine a probability of the failure event based on number of the entropic events of the corresponding group;
determine a trend based on the probabilities; and
determine, based on the trend, a time to the failure event.

20. The computer platform of claim 19, wherein the management controller to further:
extrapolate the trend to determine a future time that corresponds to a probability at or near one hundred percent, and:
determine the time to the failure event based on a current time and the future time.
